(19) United States
(12) Patent Application Publication
(10) Pub. No.: US 2006/0044301 A1
(43) Pub. Date: Mar. 2, 2006

(54) Display device and driving method thereof

(75) Inventor: Young-Suk Ha, Gunpo-si (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/080,933

(22) Filed: Mar. 14, 2005

(30) Foreign Application Priority Data
Sep. 2, 2004 (KR) 10-2004-0069867

(51) Int. Cl. G09G 5/00

(52) U.S. Cl. 345/209

(57) ABSTRACT

A device for driving a liquid crystal display including a plurality of pixels and a plurality of data lines connected to the pixels is provided. The device includes a data voltage generator generating data voltages corresponding to image data for the pixels and a voltage selector selectively outputting either the data voltages from the data voltage generator or at least one refresh voltage onto the plurality of data lines.

### BACKGROUND OF THE INVENTION

(a) Field of the Invention

The present invention relates to a display device and a driving method thereof, and in particular, to a liquid crystal display and a driving method thereof.

(b) Description of Related Art

A flat panel display such as a liquid crystal display (LCD) and an organic light emitting display (OLED) includes a display panel, a plurality of drivers for driving the display panel, and a controller for controlling the drivers.

An LCD includes a pair of panels provided with field generating electrodes and a liquid crystal (LC) layer having dielectric anisotropy, which is disposed between the two panels. The field generating electrodes generally include a plurality of pixel electrodes and connected to switching elements such as thin film transistors (TFTs) to be supplied with data voltages and a common electrode covering an entire surface of a panel and supplied with a common voltage. A pair of field generating electrodes that generate the electric field in cooperation with each other and a liquid crystal disposed therebetween form so called a liquid crystal capacitor.

The LCD applies the voltages to the field generating electrodes to generate electric field to the liquid crystal layer, and the strength of the electric field can be controlled by adjusting the voltage across the liquid crystal capacitor. Since the electric field determine the orientations of liquid crystal molecules and the molecular orientations determine the transmittance of light passing through the liquid crystal layer, the light transmittance is adjusted by controlling the applied voltages, thereby obtaining desired images.

In order to prevent image deterioration due to long-time application of the unidirectional electric field, etc., polarity of the data voltages with respect to the common voltage is reversed every frame, every row, or every dot (i.e. every pixel).

However, the polarity inversion requires large swinging of the data voltages, thereby causing high power consumption of a data driver for generating the data voltages. The power consumption may be reduced by charge sharing that connects data lines charged with data voltages having opposite polarities to make the voltages of the data lines nearly equal to the common voltage.

However, the charge sharing is not effective for some data voltage patterns. For example, when the data voltages applied to the data lines alternate black and white voltages, the voltages of the data lines that have experienced the charge sharing may be equal to a middle voltage between the black voltage and the white voltage, which is far from the common voltage.

### SUMMARY OF THE INVENTION

A device for driving a liquid crystal display including a plurality of pixels and a plurality of data lines connected to the pixels is provided. The device includes a data voltage generator generating data voltages corresponding to image data for the pixels and a voltage selector selectively outputting either the data voltages from the data voltage generator or at least one refresh voltage to the data lines.

The data voltages may have polarity inverted in a periodical manner and the at least one refresh voltage may include first and second refresh voltages having opposite polarities.

The voltage selector may output the data voltages and the at least one refresh voltage in an alternate manner. Furthermore, when the voltage selector outputs the at least one refresh voltage, the voltage selector outputs the first and the second refresh voltages in an alternate manner.

The polarity of the first and the second fresh voltages may be opposite to the polarity of previously outputted data voltages.

The data voltages may be selected from a plurality of gray voltages that are supplied from an external device or generated by the data voltage generator based on a set of reference gray voltages from an external device.

The at least one refresh voltage may be selected from the plurality of gray voltages, and the at least one refresh voltage may include the highest or the lowest one of the plurality of gray voltages subtracted by a predetermined voltage.

The voltage selector may include: a first set of switching elements connected between the data voltage generator and the data lines; and a second set of switching elements connected between the at least one refresh voltage and the data lines and operating alternate to the first set of switching elements.

The at least one refresh voltage may include first and second refresh voltages. The voltage selector may further include a switching unit alternately connecting the first and the second refresh voltages to the second set of switching elements.

The second set of switching elements may include: a third set of switching elements connected between the switching unit and the data lines where the switching unit supplies the third set of switching element with one of the first and the second refresh voltages; and a fourth set of switching elements connected between the switching unit and the plurality of data lines, separated from the third set of switching elements unit, the switching unit supplying the fourth set of switching elements with the other one of the first and the second refresh voltages.

The data voltages may have polarity inverted in a periodical manner and the first and the second refresh voltages may have opposite polarities to the data voltages previously outputted. The first and the second set of switching elements may include transmission gates.

A method of driving a liquid crystal display is provided, which includes: applying first data voltages having negative polarity to the liquid crystal display; applying a first refresh voltage to the liquid crystal display after applying the first data voltages; applying second data voltages having positive polarity to the liquid crystal display after applying the first refresh voltage; and applying a second refresh voltage different from the first refresh voltage to the liquid crystal display after applying the second data voltages.

The first refresh voltage may have positive polarity and the second refresh voltage has negative polarity, and the first and the second refresh voltages may include black or white gray voltage.

A display device is provided, which includes: a plurality of pixels for display images; and a plurality of data lines connected to the pixels and alternately transmitting data voltages and one of at least two refresh voltages to the pixels.

The display device may further include: a data voltage generator generating the data voltages corresponding to image data; and a voltage selector selectively applying either the data voltages or one of the at least two refresh voltages onto the data lines.

The at least two refresh voltages may include first and second refresh voltages having opposite polarities.

The first and the second refresh voltages may include black or white gray voltage.

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel of an LCD according to an embodiment of the present invention;

FIG. 3 is a block diagram of a data driving circuit according to an embodiment of the present invention;

FIG. 4 is a circuit diagram of a data-line charger shown in FIG. 3 according to an embodiment of the present invention;

FIG. 5 illustrates exemplary waveforms of the data driver shown in FIGS. 1-4;

FIG. 6 is an equivalent circuit diagram during a data voltage output duration; and

FIGS. 7 and 8 are equivalent circuit diagrams during the refresh voltage output durations.

### DETAILED DESCRIPTION OF EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Like numerals refer to like elements throughout.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, liquid crystal displays as an example of display devices according to embodiments of the present invention will be described with reference to the accompanying drawings.

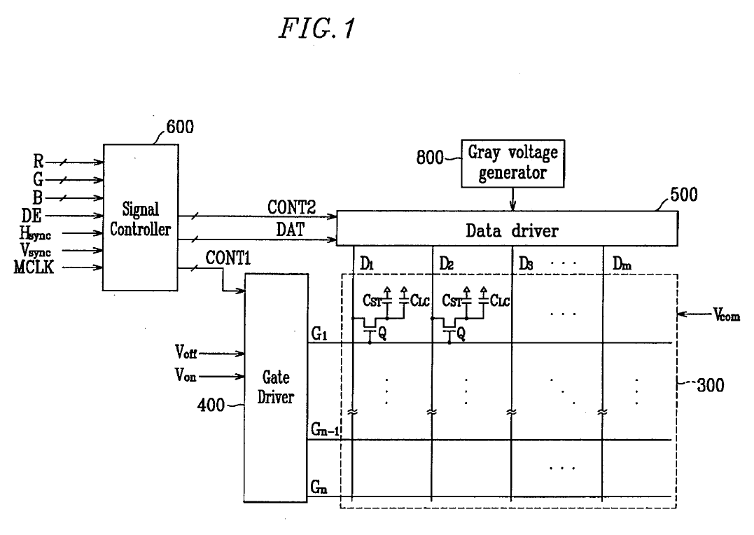

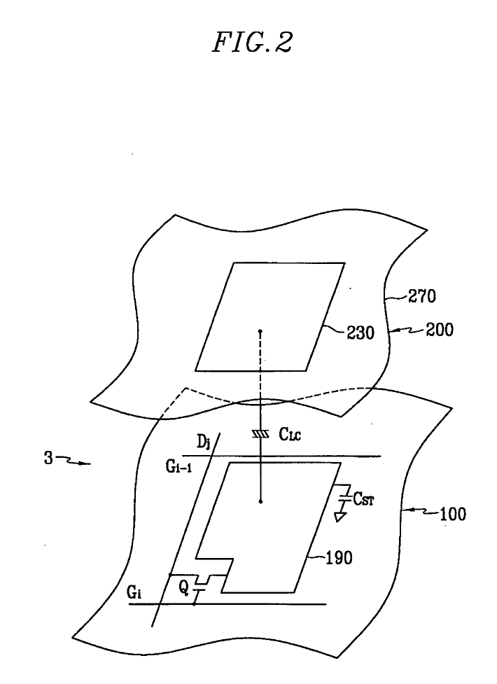

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator 800 connected to the data driver 500, and a signal controller 600 controlling the above elements.

Referring to FIG. 1, the panel assembly 300 includes a plurality of display signal lines G₁-Gₙ and D₁-Dₘ and a plurality of pixels connected thereto and arranged substantially in a matrix. In a structural view shown in FIG. 2, the panel assembly 300 includes lower and upper panels 100 and 200 and a LC layer 3 interposed therebetween.

The display signal lines G₁-Gₙ and D₁-Dₘ are disposed on the lower panel 100 and include a plurality of gate lines G₁-Gₙ transmitting gate signals (also referred to as “scanning signals”), and a plurality of data lines D₁-Dₘ transmitting data signals. The gate lines G₁-Gₙ extend substantially in a row direction and substantially parallel to each other, while the data lines D₁-Dₘ extend substantially in a column direction and substantially parallel to each other.

Each pixel includes a switching element Q connected to a respective one of the signal lines G₁-Gₙ and a respective one of the signal lines D₁-Dₘ, and a LC capacitor C_{LC} and a storage capacitor C_{ST} that are connected to the switching element Q. The storage capacitor CST is optional and may be omitted.

The switching element Q including a TFT is provided on the lower panel 100 and has three terminals: a control terminal connected to one of the gate lines G₁-Gₙ; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q, and the common electrode 270 is supplied with a common voltage Vcom and covers an entire surface of the upper panel 200. Alternately, the common electrode 270 may be provided on the lower panel 100, and both electrodes 190 and 270 may have shapes of bars or stripes.

The storage capacitor CST is an auxiliary capacitor for the LC capacitor C_{LC}. The storage capacitor CST includes the pixel electrode 190 and a separate signal line, which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of the primary colors (i.e., spatial division) or each pixel sequentially represents the primary colors in turn (i.e., temporal division) such that spatial or temporal sum of the primary colors is recognized as a desired color. An example of a set of the primary colors includes red, green, and blue. FIG. 2 shows an example of the implementation of spatial division for color display. Each pixel includes a color filter 230 representing one of the primary colors in an area of the upper panel 200 facing the pixel electrode 190. Alternatively, the color filter 230 is provided on or under the pixel electrode 190 on the lower panel 100.

One or more polarizers (not shown) are attached to at least one of the panels 100 and 200.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom. The positive-polarity gray voltages range from a positive black voltage (denoted by Vb+) giving a black state to a positive white voltage giving a white state (denoted by Vw+), while the negative-polarity gray voltages range from a negative black voltage (denoted by Vb−) giving a black state to a negative white voltage giving a white state (denoted by Vw−). The black and white voltages Vb+, Vb−, Vw+, and Vw− are the highest or lowest of the gray voltages subtracted by the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ. The data driver 500 further applies a predetermined voltage to the data lines D₁-Dₘ, which will be described later in detail.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternately, the drivers 400 and 500 may be integrated into the panel assembly 300 along with the display signal lines G₁-Gₙ and D₁-Dₘ and the TFT switching elements Q.

The signal controller 600 controls the gate driver 400 and the gate driver 500.

Now, the operation of the above-described LCD will be described in detail.

The signal controller 600 is supplied with input image signals R, G and B and input control signals controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and processing the image signals R, G and B suitable for the operation of the panel assembly 300 on the basis of the input control signals and the input image signals R, G and B, the signal controller 600 transmits the gate control signals CONT1 to the gate driver 400, and the processed image signals DAT and the data control signals CONT2 to the data driver 500.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of start of data transmission for a group of pixels, a load signal LOAD for instructing to apply the data voltages to the data lines D₁-Dₘ, and a data clock signal HCLK. The data control signal CONT2 may further include an inversion signal RVS for reversing the polarity of the data voltages (with respect to the common voltage Vcom).

Responsive to the data control signals CONT2 from the signal controller 600, the data driver 500 receives a packet of the image data DAT for a group of pixels from the signal controller 600, converts the image data DAT into analog data voltages selected from the gray voltages supplied from the gray voltage generator 800, and applies the data voltages to the respective data lines D₁-Dₘ.

The gate driver 400 applies the gate-on voltage Von to the gate lines G₁-Gₙ in response to the gate control signals CONT1 from the signal controller 600, thereby turning on the switching elements Q connected to the respective gate line. The data voltages applied to the data lines D₁-Dₘ are supplied to the respective pixels through the activated switching elements Q.

The difference between the data voltage and the common voltage Vcom is represented as a voltage across the LC capacitor C_{LC}, which is referred to as a pixel voltage. The LC molecules in the LC capacitor C_{LC} have orientations depending on the magnitude of the pixel voltage, and the molecular orientations determine the polarization of light passing through the LC layer 3. The polarizer(s) converts the light polarization into light transmittance.

By repeating this procedure for a unit of the horizontal period (which is denoted by “1H” and equal to one period of the horizontal synchronization signal Hsync and the data enable signal DE), all gate lines G₁-Gₙ are sequentially supplied with the gate-on voltage Von during a frame, thereby applying the data voltages to all pixels in the matrix. When the next frame starts after the previous frame is completed, the inversion control signal RVS applied to the data driver 500 is controlled such that the polarity of the data voltages is reversed (which is referred to as “frame inversion”). The inversion control signal RVS may be also controlled such that the polarity of the data voltages flowing in a data line within a frame are reversed (for example, line inversion and dot inversion), or the polarity of the data voltages in one packet are reversed (for example, column inversion and dot inversion).

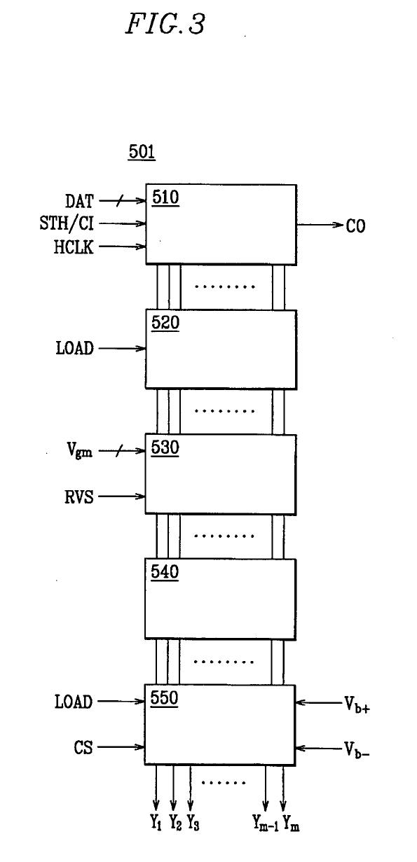

Now, a data driver for an LCD according to an embodiment will be described in detail with reference to FIG. 3 as well as FIGS. 1 and 2.

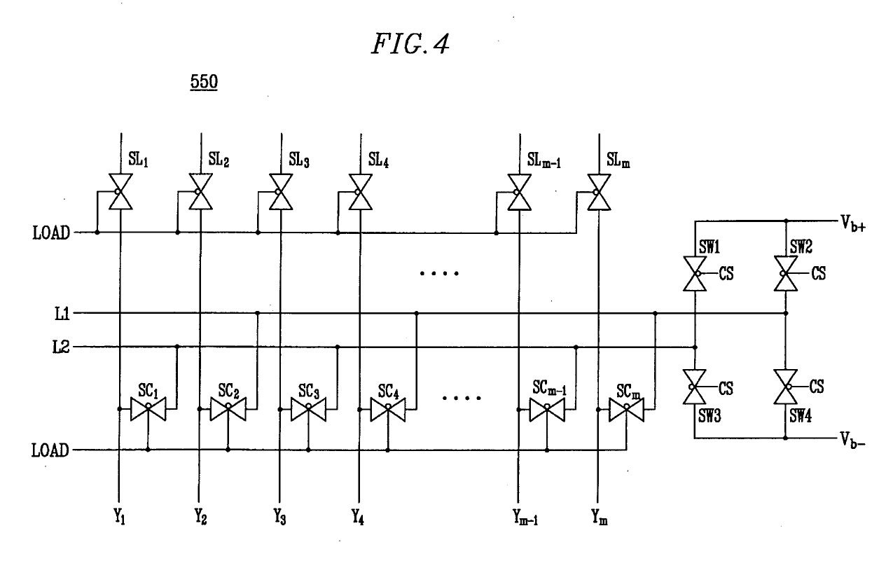

FIG. 3 is a block diagram of a data driving circuit according to an embodiment of the present invention, and FIG. 4 is a circuit diagram of a data-line charger shown in FIG. 3 according to an embodiment of the present invention.

As shown in FIG. 3, a data driving circuit 501 according to this embodiment includes a shift register 510, a latch 520, a digital-to-analog (DA) converter 530, a buffer 540, and a data-line charger 550. One or more data driving circuits 510 may form a data driver 500.

The shift register 510 receives image data DAT, a horizontal synchronization start signal STH or a shift clock signal (or carry in signal) CI, and a data clock HCLK from a signal controller, such as signal controller 600 shown in FIG. 1. Responsive to the horizontal synchronization start signal STH or the shift clock signal CI, the shift register 510 sequentially picks up and transmits the image data DAT to the latch 520 in synchronization with the data clock HCLK. After picking up and transmitting all the image data assigned to the data driving circuit 501, the shift register 510 outputs a carry out signal CO to a shift register (not shown) of a next data driving circuit (not shown) if it exists.

The latch 520 sequentially receives and stores the image data DAT until the last image data for the driving circuit 501 is inputted. The latch 520 outputs the stored image data DAT to the DA converter 530 in response to a load signal supplied from the signal controller 600.

The DA converter 530 selectively receives one of positive and negative sets of gray voltages Vgm supplied from a gray voltage generator, such as gray voltage generator 800 shown in FIG. 1 in accordance with an inversion control signal RVS supplied from the signal controller 600. Alternatively, the gray voltage generator 800 may generate only a few number of gray voltages referred to as reference gray voltages, and the data driving circuit 501 may further include a voltage divider (not shown) dividing the reference voltages into a total number of gray voltages to be transmitted to the DA converter 530. The DA converter 530 converts the image data DAT supplied from the latch 520 into analog data voltages selected from the selected set of the gray voltages Vgm.

The buffer 540 temporarily stores the data voltages supplied from the DA converter 530 and outputs the stored data voltages to the charger 550. The duration of the output of the data voltages is equal to one horizontal period (1H).

The charger 550 has a plurality of output terminals Y₁-Yₘ connected to data lines D₁-Dₘ, which serve as output terminals of the data driving circuit 501. The output terminals Y₁-Yₘ selectively outputs the data voltages from the buffer or refresh voltages.

As shown in FIG. 4, an exemplary charger 550 includes a plurality of data-voltage control switching elements SL₁-SLₘ connected between the buffer 540 and the output terminals Y₁-Yₘ, a plurality of refresh-voltage control switching elements SC₁-SCₘ connected between respective first and second refresh voltage lines L1 and L2 and the output terminals Y₁-Yₘ, and four voltage selection switching elements SW1-SW4 connected between respective first and second refresh voltage lines L1 and L2 and positive and negative black voltages Vb+ and Vb− serving as the refresh voltages.

The switching elements SL₁-SLₙ, SC₁-SCₘ and SW1-SW4 include transmission gates. A transmission gate has a control terminal and an inverted control terminal that are supplied with a signal having different levels. For example, the transmission gate turns on when a high-level voltage is applied to the control terminal and a low-level voltage is applied to the inverted control terminal. On the contrary, the transmission gate turns off when a low-level voltage is applied to the control terminal and a high-level voltage is applied to the inverted control terminal.

The data-voltage control switching elements SL₁-SLₘ control the transmission of the data voltages from the buffer 540 based on a load signal applied to the inverted control terminals of the switching elements. For example, the switching elements SL₁-SLₘ transmit the data voltages to the output terminals Y₁-Yₘ when the load signal LOAD is in a low state, while they block the data voltages when the load signal LOAD is in a high state.

The refresh-voltage control switching elements SC₁-SCₘ alternately connected to the pair of refresh voltage lines L1 and L2. For example, odd switching elements SC₁, SC₃, . . . , which are connected to odd output terminals Y₁, Y₃, . . . , are connected to the second refresh voltage line L2, while even switching elements SC₂, SC₄, . . . , which are connected to even output terminals Y₂, Y₄ . . . . , are connected to the first refresh voltage line L1 as shown in FIG. 4. The switching elements SC₁-SCₘ control the connection between the refresh voltage lines L1 and L2 and the output terminals Y₁-Yₘ. Specifically, switching elements SC₁-SCₘ are controlled by the load signal LOAD in reverse polarity to the load signal applied to control switching elements SL₁-SL_{M}. Thus, the switching elements SC₁-SCₘ transmit the voltage exerted on the refresh voltage lines L1 and L2 to the output terminals Y₁-Yₘ when the load signal LOAD is in the high state, and block the reference voltages when the load signal is in the low state.

The voltage selection switching elements SW1-SW4 are connected between the second refresh voltage line L2 and the positive black voltage Vb+, between the first refresh voltage line L1 and the positive black voltage Vb+, between the second refresh voltage line L2 and the negative black voltage Vb−, and between the first refresh voltage line L1 and the negative black voltage Vb−, respectively. The switching elements SW1-SW4 transmit the positive and the negative black voltages Vb+ and Vb− to the first and the second refresh voltage lines L1 and L2 according to a switching signal CS that may include an inversion control signal RVS. For example, when the switching signal CS is in a high level, the switching elements SW2 and SW3 are turned on to transmit the positive black voltage Vb+ to the first refresh voltage line L1 and to transmit the negative black voltage Vb− to the second refresh voltage line L2, respectively, while the switching elements SW1 and SW4 are turned off. On the contrary, when the switching signal CS is in a low level, the first and the second refresh voltage lines L1 and L2 are supplied with the negative black voltage Vb− and the positive black voltage Vb+, respectively.

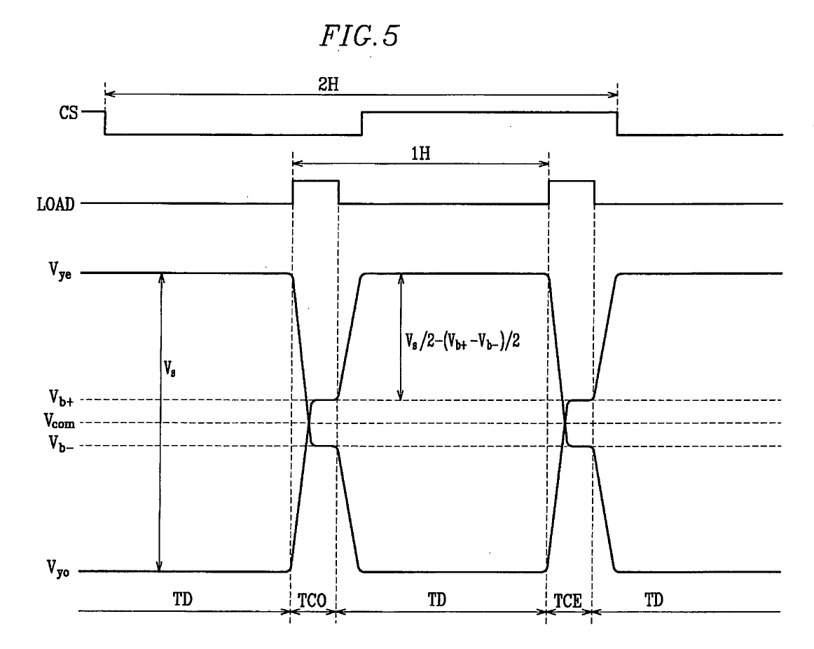

The operation of the data driver shown in FIGS. 1-4 will be described in detail with reference to FIGS. 5-8.

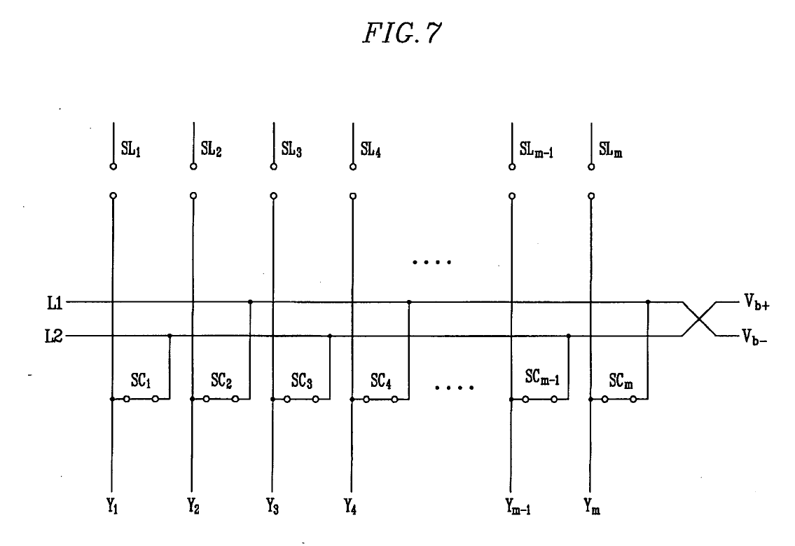

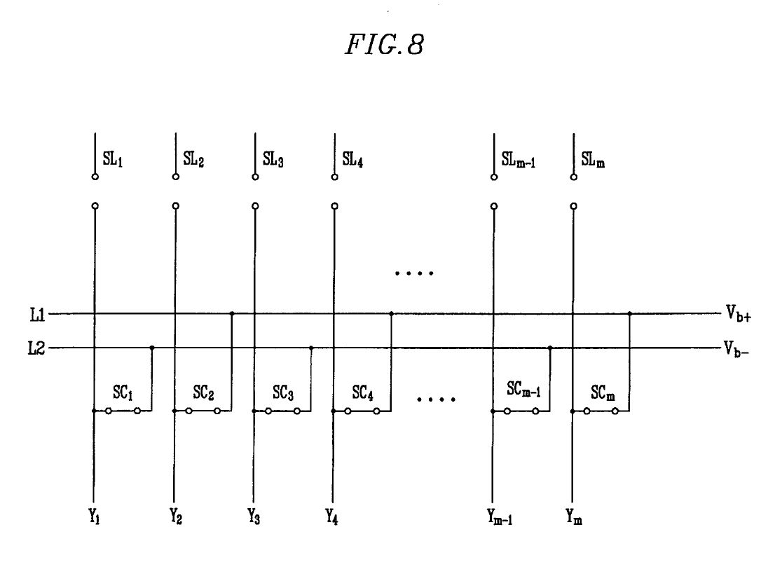

FIG. 5 illustrates exemplary waveforms of the data driver shown in FIGS. 1-4, FIG. 6 is an equivalent circuit diagram during a data voltage output duration (TD), and FIGS. 7 and 8 are equivalent circuit diagrams during the refresh voltage output durations. Specifically, FIG. 7 is an equivalent circuit diagram during the refresh voltage output duration TCO and FIG. 8 is an equivalent circuit diagram during the refresh voltage output duration TCE.

Referring to FIG. 5, a data driving circuit 501 for a normally black mode LCD performs one-dot inversion along with a frame inversion. For example, when the polarity of data voltages outputted from the odd output terminals Y₁, Y₃, . . . is negative and the polarity of data voltages outputted from the even output terminals Y₂, Y₄, . . . is positive in a first frame, the polarities thereof are interchanged in a next frame. In addition, the data driving circuit 501 outputs refresh voltages between the outputs of the data voltages in adjacent frames, which will be described in detail.

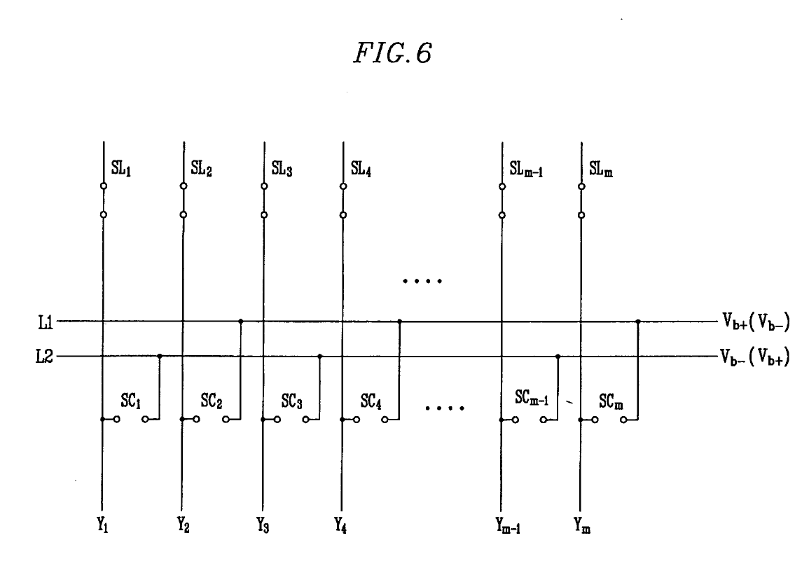

During a data voltage output duration TD in a first frame, the load signal LOAD is in a low state such that the data driving circuit 501 maintains the voltage output. The data-voltage control switching elements SL₁-SLₘ turn on to pass the data voltages while the refresh-voltage control switching elements SC₁-SCₘ turn off to block the refresh voltages as shown in FIG. 6 such that the data driving circuit 501 outputs the data voltages. Accordingly, output voltages Vyo of the odd output terminals Y₁, Y₃, . . . (referred to as “odd terminal output voltages” hereinafter) have negative polarity, and output voltages Vye of the even output terminals Y₂, Y₄, . . . (referred to as “even terminal output voltages” hereinafter) have positive polarity.

When the load signal LOAD becomes high to start a refresh voltage output duration TCO, the switching elements SL₁-SLₘ turn off to block the data voltages and the switching elements SC₁-SCₘ turn on to pass the refresh voltages as shown in FIG. 7 such that the data driving circuit 501 outputs the refresh voltages. Since the switching signal CS is in a low state, the switching elements SW1 and SW4 turn on and the switching elements SW2 and SW3 turn off such that the refresh voltages exerted on the first and the second refresh voltage lines L1 and L2 are equal to the negative and the positive black voltage Vb− and Vb+, respectively. Accordingly, the polarity of the output voltages Vyo and Vye is inverted.

When the load signal LOAD becomes low again to start a next data voltage output duration, the data driving circuit 501 outputs the data voltages and the output voltages Vyo and Vye maintain their polarity.

When the load signal LOAD becomes high again to start a next refresh voltage output duration TCE, the data driving circuit 501 outputs the refresh voltages and the output voltages Vyo and Vye reverse their polarity.

In the meantime, the above-described data driving circuit implemented in an IC chip has power consumption P given by:

$$P ∝ m \times C \times [ \frac{Vs}{2} - \frac{( Vb + ) - ( Vb - )}{2} ] \times F ,$$

where m is the number of the channels of the IC chips, C is the capacitance of the data lines, Vs is the swinging width of the data voltages shown in FIG. 5, and F is the horizontal frequency.

In comparison, conventional data driving chips without and with charge sharing have respective power consumptions given by:

$$\begin{matrix}P ∝ m \times C \times Vs \times F ; and \\ P ∝ m \times C \times \frac{Vs}{2} \times F .\end{matrix}$$

Accordingly, the power consumption of the data driving IC chip according the embodiment of the present invention is smaller than those of the conventional data driving IC chips.

The data driver shown in FIGS. 3-8 may have various modifications.

For example, in the above descriptions, data driving circuit 501 performs one-dot inversion along with a frame inversion. In other embodiments, the data driving circuit can perform other types of inversion schemes, such as line inversion or frame inversion. In that case, the data line charger of the data driving circuit may employ only one refresh voltage and all the data lines are driven to the same refresh voltage.

In another embodiment, a data driver for a normally white mode LCD may substitute the black voltages Vb+ and Vb− with the white voltages Vw+ and Vw−.

Alternatively, the black voltages Vb+ and Vb− may be substituted with the common voltage Vcom.

The transmission gates of the switching elements SL₁-SLₘ, SC₁-SCₘ and SW1-SW4 may be substituted with other switching elements such as TFTs.

The data driver 500 may perform double-dot inversion rather than one dot inversion.

The charger 550 may be implemented as a stand-alone device, which may be mounted on the panel assembly 300.

The data driver 550 may be employed in other display devices.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A device for driving a liquid crystal display including a plurality of pixels and a plurality of data lines connected to the pixels, the device comprising:
a data voltage generator generating data voltages corresponding to image data for the pixels; and
a voltage selector selectively outputting either the data voltages from the data voltage generator or at least one refresh voltage onto the plurality of data lines.

2. The device of claim 1, wherein the data voltages have polarity inverted in a periodical manner.

3. The device of claim 2, wherein the at least one refresh voltage comprises first and second refresh voltages having opposite polarities.

4. The device of claim 3, wherein the voltage selector outputs the data voltages and the at least one refresh voltage in an alternate manner.

5. The device of claim 4, wherein when the voltage selector outputs the at least one refresh voltage, the voltage selector outputs the first and the second refresh voltages in an alternate manner.

6. The device of claim 5, wherein the polarity of the first and the second fresh voltages being outputted is opposite to the polarity of previously outputted data voltages.

7. The device of claim 1, wherein the data voltages are selected from a plurality of gray voltages that are supplied from an external device or generated by the data voltage generator based on a set of reference gray voltages from an external device.

8. The device of claim 7, wherein the at least one refresh voltage are selected from the plurality of gray voltages.

9. The device of claim 8, wherein the at least one refresh voltage comprises the highest or the lowest one of the plurality of gray voltages subtracted by a predetermined voltage.

10. The device of claim 1, wherein the voltage selector comprises:
a first set of switching elements connected between the data voltage generator and the plurality of data lines; and
a second set of switching elements connected between the at least one refresh voltage and the plurality of data lines and operating alternate to the first set of switching elements.

11. The device of claim 10, wherein the at least one refresh voltage comprises first and second refresh voltages.

12. The device of claim 11, wherein the voltage selector further comprises a switching unit alternately connecting the first and the second refresh voltages to the second set of switching elements.

13. The device of claim 12, wherein the second set of switching elements comprise:
a third set of switching elements connected between the switching unit and the plurality of data lines, the switching unit supplying the third set of switching elements with one of the first and the second refresh voltages; and
a fourth set of switching elements connected between the switching unit and the plurality of data lines, separated from the third set of switching elements unit, the switching unit supplying the fourth set of switching elements with the other one of the first and the second refresh voltages.

14. The device of claim 13, wherein the data voltages have polarity inverted in a periodical manner and the first and the second refresh voltages have opposite polarities to the data voltages previously outputted.

15. The device of claim 14, wherein the first and the second sets of switching elements comprise transmission gates.

16. A method of driving a liquid crystal display, the method comprising:
applying first data voltages having negative polarity to the liquid crystal display;
applying a first refresh voltage to the liquid crystal display after applying the first data voltages;
applying second data voltages having positive polarity to the liquid crystal display after applying the first refresh voltage; and
applying a second refresh voltage different from the first refresh voltage to the liquid crystal display after applying the second data voltages.

17. The method of claim 16, wherein the first refresh voltage has positive polarity and the second refresh voltage has negative polarity.

18. The method of claim 17, wherein the first and the second refresh voltages comprise black or white gray voltages.

19. A display device comprising:
a plurality of pixels for display images; and
a plurality of data lines connected to the pixels and alternately transmitting data voltages and one of at least two refresh voltages to the pixels.

20. The display device of claim 19, further comprising:
a data voltage generator generating the data voltages corresponding to image data; and
a voltage selector selectively applying either the data voltages or one of the at least two refresh voltages onto the plurality of data lines.

21. The display device of claim 20, wherein the at least two refresh voltages comprise first and second refresh voltages having opposite polarities.

22. The method of claim 21, wherein the first and the second refresh voltages comprise black or white gray voltages.
